(19) United States
(12) Patent Application Publication
(10) Pub. No.: US 2013/0314367 A1
(43) Pub. Date: Nov. 28, 2013

(54) Touch Gesture Identification Method for Surface Capacitive Touch Screen

(71) Applicant: Chuang Yung-Chuan, Taipei (TW)

(72) Inventor: Chuang Yung-Chuan, Taipei (TW)

(73) Assignee: XUYE TECHNOLOGY CO. LTD., New Taipei (TW)

(21) Appl. No.: 13/602,108

(22) Filed: Sep. 1, 2012

(30) Foreign Application Priority Data
May 23, 2012 (TW) 101209813

(51) Int. Cl. G06F 3/044

(52) U.S. Cl. 345/174

(57) ABSTRACT

The present invention relates to a touch gesture identification method for a surface capacitive touch screen, so as to identify touch gestures executed by at least two touching objects to the surface capacitive touch screen having a transparent substrate, an electrode layer and a transparent protection layer. The surface capacitive touch screen has advantages of simple framework, easy to be manufactured and low cost, so that this surface capacitive touch screen is widely applied in electronic and electrical products with different screen sizes. The main feature of the method is that the displaying images on the touch screen can be zoom in or zoom out by way of computing the difference between a first-time sensed current and a second-time sensed current resulted from the touch gestures executed by the two touching objects and detected by the surface capacitive touch screen.

### BACKGROUND OF THE INVENTION

1. Technical Field

The present invention relates to a touch gesture identification method for touch screens, and more particularly to a touch gesture identification method capable of being applied in surface capacitive touch screens with various screen sizes for detecting and identifying a touch gesture made by two touching objects.

2. Description of Related Art

With the progress of science and technology, 3C products, such as mobile phones, tablet PCs or notebooks, now include touch screens instead of traditional liquid crystal display (LCD) screens.

By technology principles, the touch screens are divided into resistive touch screen, capacitive touch screen, infrared-ray touch screen, surface acoustic wave touch screen, electromagnetic touch screen, and optical touch screen; in which, the capacitive touch screen is widely used in various electronic products because of having the advantages of high transmittance, flexible touch and long service life. Please refer to FIG. 1, there is shown an exploded view of a conventional capacitive touch screen. As shown in FIG. 1, the conventional capacitive touch screen 10′ includes: a transparent substrate 11′, an electrode layer 13′ and a protection layer 14′, wherein the electrode layer 13′ includes a transparent conductive layer 130′, and two opposite X electrodes 131′ and Y electrodes 132′ are formed around the side edges of the transparent conductive layer 130′.

Please simultaneously refer to FIG. 2, which illustrates a schematic signal receiving diagram of the conventional capacitive touch screen. As shown in FIG. 2, four conducting wires 151, 152, 153, and 154 are connected to four corners of the capacitive touch screen 10′, used to receive four AC signal AC1′, AC2′, AC3′, and AC4′ for detecting and computing a touch point P′ on the capacitive touch screen 10′. When the capacitive touch screen 10′ is operated, the AC signal (AC1′, AC2′, AC3′, and AC4′) is a voltage signal with square wave or sine wave, and the four conducting wires (151′, 152′, 153′, and 154′) conduct currents I1′, I2′, I3′, and I4′, respectively. Therefore, touch point P′ can be computed by measuring current differences ΔI1′, ΔI2′, ΔI3′, and ΔI4′ of the conducting wires (151′, 152′, 153′, and 154′), wherein the touch point P′ is computed by following formula:

X=(ΔI3+ΔI4−ΔI1−ΔI2)/(ΔI1+ΔI2+ΔI3+ΔI4)

Y=(ΔI1+ΔI4−ΔI3−ΔI2)/(ΔI1+ΔI2+ΔI3+ΔI4)

The technology framework of the above-mentioned capacitive touch screen 10′ is very simple, so that the capacitive touch screen 10′ has the advantages of low cost and easy to be produced. However, this capacitive touch screen 10′ cannot provide multi touch (MT) function, and that is the main drawback of the capacitive touch screen 10′. When two touch points are made on the capacitive touch screen 10′ for carrying out a touch gesture, for example, zoom-in gesture or zoom-out gesture, the currents conducted by the conducting wires may counteract to each other due to the positions of the two touch points are opposite, so that the touch points cannot and the touch gesture cannot be determined. For above reason, it can easily know that the capacitive touch screen 10′ is not an ideal touch technology.

Accordingly, in view of the surface capacitive touch screen 10′ is not an ideal touch technology, the touch manufacturers propose a projected capacitive touch screen in order to solve the drawback of the surface capacitive touch screen 10′. Please refer to FIG. 3, there is shown an exploded view of a projected capacitive touch screen. As shown in FIG. 3, the projected capacitive touch screen 20′ includes: a Y electrode layer 24′, a transparent dielectric layer 23′, an X electrode layer 22′, and a transparent substrate 21′, wherein a plurality of sensing elements 25′ are formed the Y electrode layer 24′ and the X electrode layer 22′ by rows and columns. These sensing elements 25′ are respectively connected with a plurality of conducting wires 28′, and used for sensing at least one touch point on the projected capacitive touch screen 20′.

Comparing to the surface capacitive touch screen 10′, this projected capacitive touch screen 20′ includes multi layers for constituting a sensing matrix pattern; therefore, the multitouch (MT) operation can be achieve when the projected capacitive touch screen 20′ is operated. However, since the projected capacitive touch screen 20′ uses the sensing matrix (including multi-column sensing and multi-row sensing) to detecting the touch points, the sensing matrix technology is still an advanced technology, such that the projected capacitive touch screen 20′ has the disadvantages of cannot be easily manufactured and high cost.

According to above descriptions, it is able to know that the projected capacitive touch screen 20′ can not be widely applied because of high cost and complex manufacturing. For this reason, the projected capacitive touch screen 20′ is merely applied on the electronic products with small screen size, such as smart phones and tablet PCs. On the contrary, because the projected capacitive touch screen 20′ has the disadvantages of cannot be easily manufactured and high cost, the projected capacitive touch screen 20′ can not be applied the electronic products with large screen size, for example, notebooks, industrial PCs, POS systems, ATMs, medical devices, monitors, game consoles, game machines, etc.

Thus, to make the surface capacitive touch screen simultaneously include the functions of “multitouch” and “touch gesture sensing” and capable of being applied on the electronics devices with different screen sizes becomes the most important issue. And accordingly, in view of the shortcoming of the conventional stylus, the inventor of the present application has made great efforts to make inventive research thereon and eventually provided a touch Gesture identification method for surface capacitive touch screen.

### BRIEF SUMMARY OF THE INVENTION

The primary objective of the present invention is to provide a touch Gesture identification method for surface capacitive touch screen, which can be used for identifying a touch gesture made by at least two touching objects to a surface capacitive touch screen, and then zooming in or zooming out the displaying images on the screen by way of computing the difference between a first-time sensed current and a second-time sensed current resulted from the touch gesture; This method includes the advantages of simple framework, easy to be manufactured and low cost and can be widely applied in the surface capacitive touch screens with various screen sizes.

Accordingly, for achieving the above objective of the present invention, the inventors propose a touch Gesture identification method for surface capacitive touch screen, which is used for identifying a touch gesture made by at least two touching objects to a surface capacitive touch screen having a transparent substrate, an electrode layer and a transparent protection layer, and comprises the steps of:

(1) at least two touching objects touching the transparent protection layer of the surface capacitive touch screen at a first time;
(2) a first conducting wire, a second conducting wire, a third conducting wire, and a fourth conducting wire of a transparent conductive layer of the electrode layer producing a first-time first current, a first-time second current, a first-time third current, and a first-time fourth current, respectively;
(3) computing the summation of the first-time first current and the first-time third current, and the summation of the first-time second current and the first-time fourth current;
(4) the touching objects touching the transparent protection layer of the surface capacitive touch screen at a second time;
(5) the first conducting wire, the second conducting wire, the third conducting wire, and the fourth conducting wire of the transparent conductive layer of the electrode layer producing a second-time first current, a second-time second current, a second-time third current, and a second-time fourth current, respectively;
(6) computing the summation of the second-time first current and the second-time third current, and the summation of the second-time second current and the second-time fourth current;
(7) determining whether the summation of the second-time first current and the second-time third current is greater than the summation of the first-time first current and the first-time third current, or the summation of the second-time second current and the second-time fourth current is greater than the summation of the first-time second current and the first-time fourth current, if yes, going to step (8); otherwise, going to step (9);
(8) zooming in the displaying images on the surface capacitive touch screen, and ending the steps; and
(9) zooming out the displaying images on the surface capacitive touch screen, and ending the steps.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is an exploded view of a conventional capacitive touch screen;

FIG. 2 is a schematic signal receiving diagram of the conventional capacitive touch screen;

FIG. 3 is an exploded view of a projected capacitive touch screen;

FIG. 4 is an exploded view of a surface capacitive touch screen according to the present invention;

FIG. 5 is a schematic signal receiving diagram of the surface capacitive touch screen according to the present invention; and

FIG. 6A and FIG. 6B are flow charts of a touch gesture identification method for the surface capacitive touch screen according to the present invention.

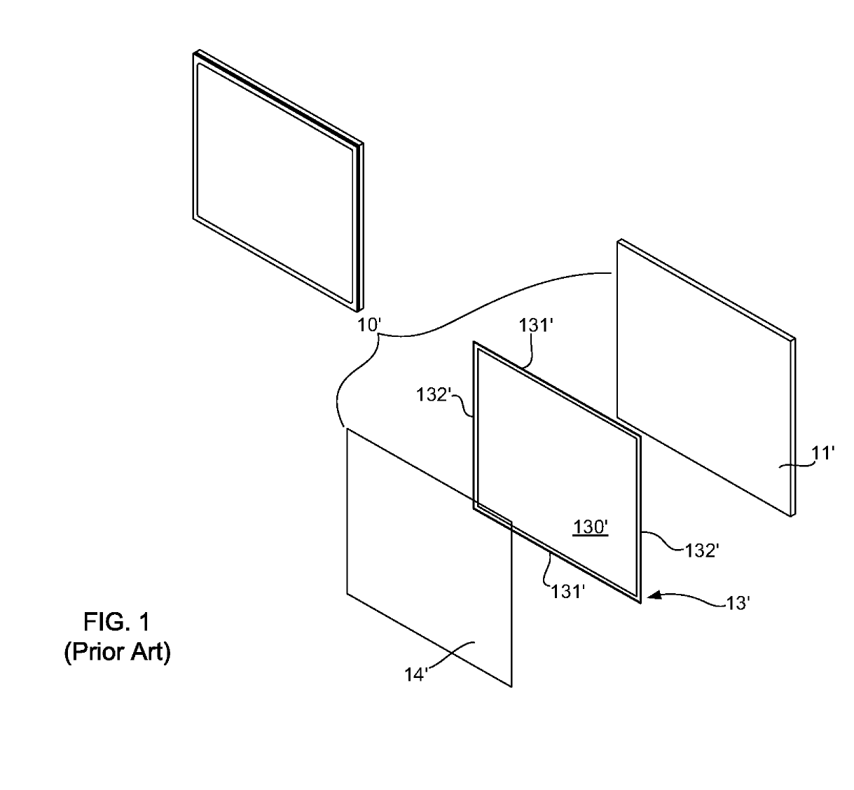

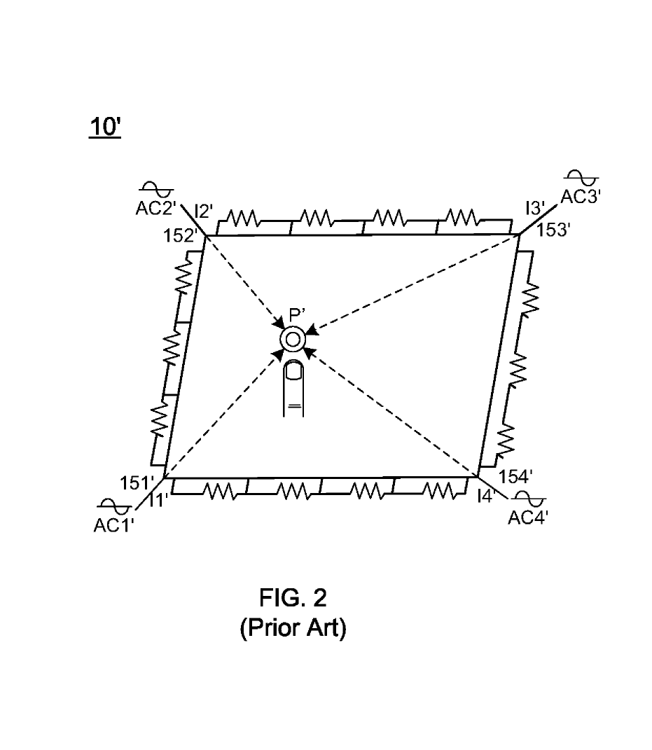

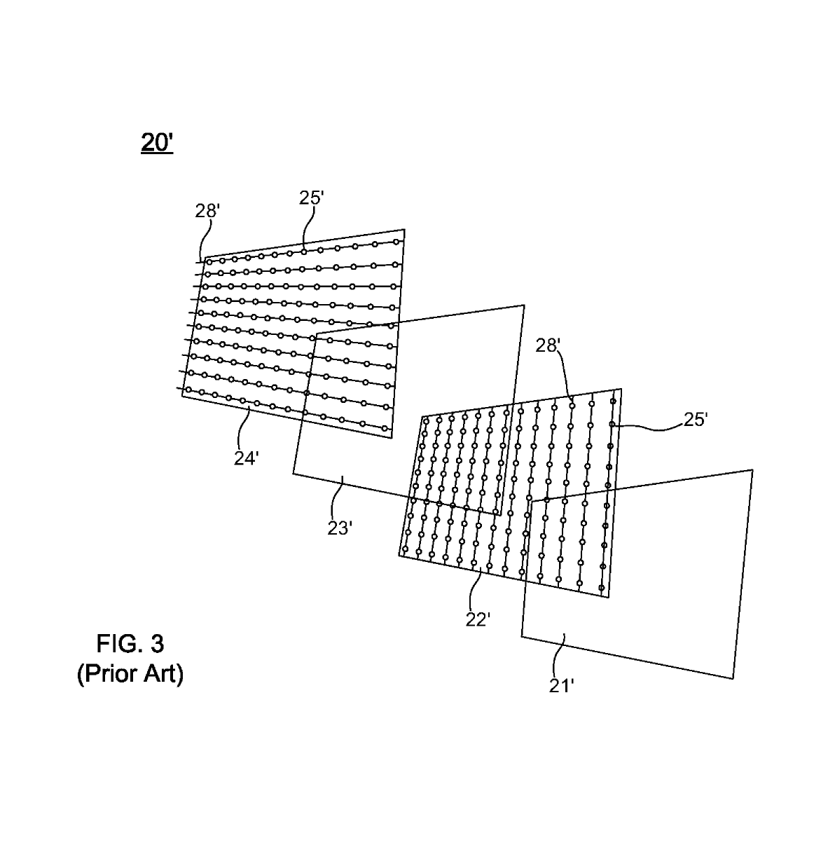

### DETAILED DESCRIPTION OF THE INVENTION

To more clearly describe a touch gesture identification method for a surface capacitive touch screen according to the present invention, embodiments of the present invention will be described in detail with reference to the attached drawings hereinafter:

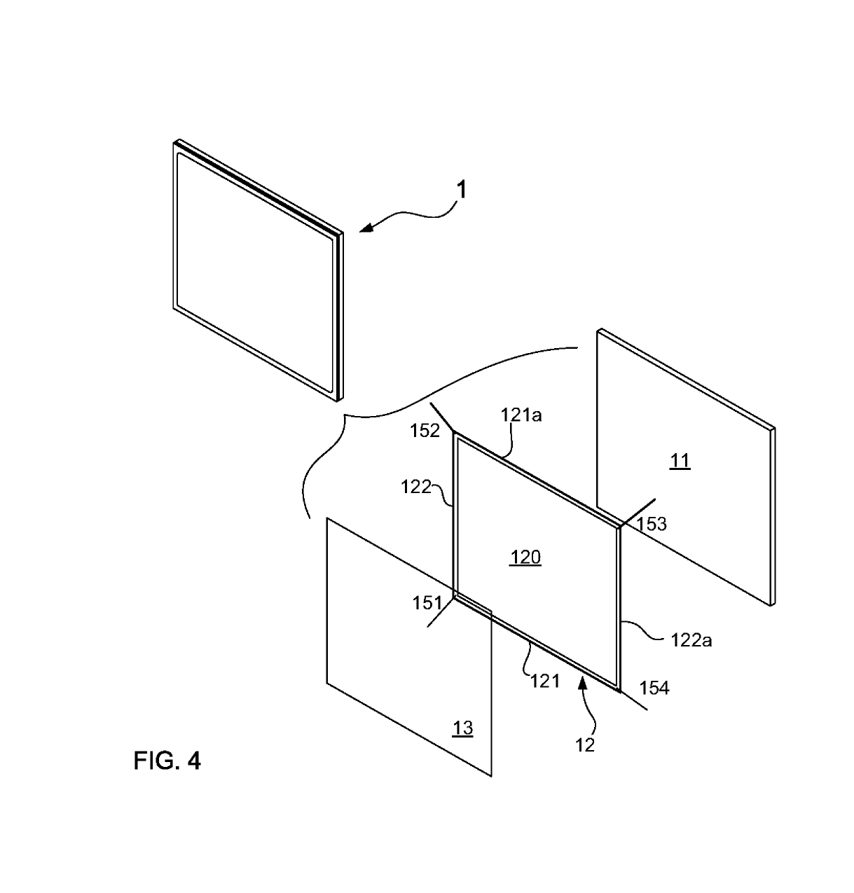

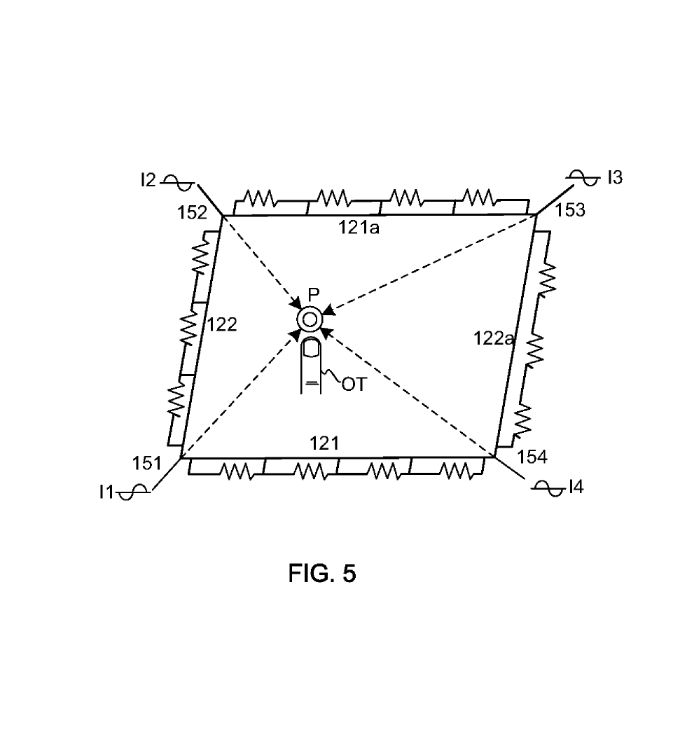

Before describing the touch gesture identification method for the surface capacitive touch screen of the present invention, the structure of the surface capacitive touch screen must be introduced firstly. Please refer to FIG. 4 and FIG. 5, which illustrate an exploded view and a schematic signal receiving diagram of the surface capacitive touch screen. As shown in FIG. 4 and FIG. 5, the surface capacitive touch screen includes: a transparent substrate 11, an electrode layer 12 and a transparent protection layer 13, wherein the material of the transparent substrate 11 can be glass, polymethylmethacrylate (PMMA) or polyethylene terephthalate (PET). The transparent protection layer 13 is used for covering and protecting the electrode layer 12 and the material thereof can be SiO₂, glass, PMMA, or PET.

The electrode layer 12 is disposed on the transparent substrate 11 and includes a transparent conductive layer 120. The material of the transparent conductive layer 120 can be Indium-Tin-Oxide (ITO) or carbon nanotube (CNT), and the side edges of the transparent conductive layer 120 are formed with a first X electrode 121, a second X electrode 121a, a first Y electrode 122, and a second Y electrode 122a, respectively; in which two ends of the first X electrode 121 are connected to the first Y electrode 122 and the second Y electrode 122a; And the second X electrode 121a is opposite to the first X electrode 121 and connected to the first Y electrode 122 and the second Y electrode 122a by two ends thereof

Inheriting to above descriptions, moreover, the connecting end of the first X electrode 121 and the first Y electrode 122 is coupled with a first conducting wire 151, the connecting end of the first Y electrode 122 and the second X electrode 121a is coupled with a second conducting wire 152, the connecting end of the second X electrode 121a and the second Y electrode 122a is coupled with the third conducting wire 153, and the connecting end of the second Y electrode 122a and the first X electrode 121 is coupled with the fourth conducting wire 154. As shown in FIG. 5, a first current I₁, a second current I₂, a third current I₃, and a fourth current I₄ flow through the first conducting wire 151, the second conducting wire 152, the third conducting wire 153, and the fourth conducting wire 154, respectively.

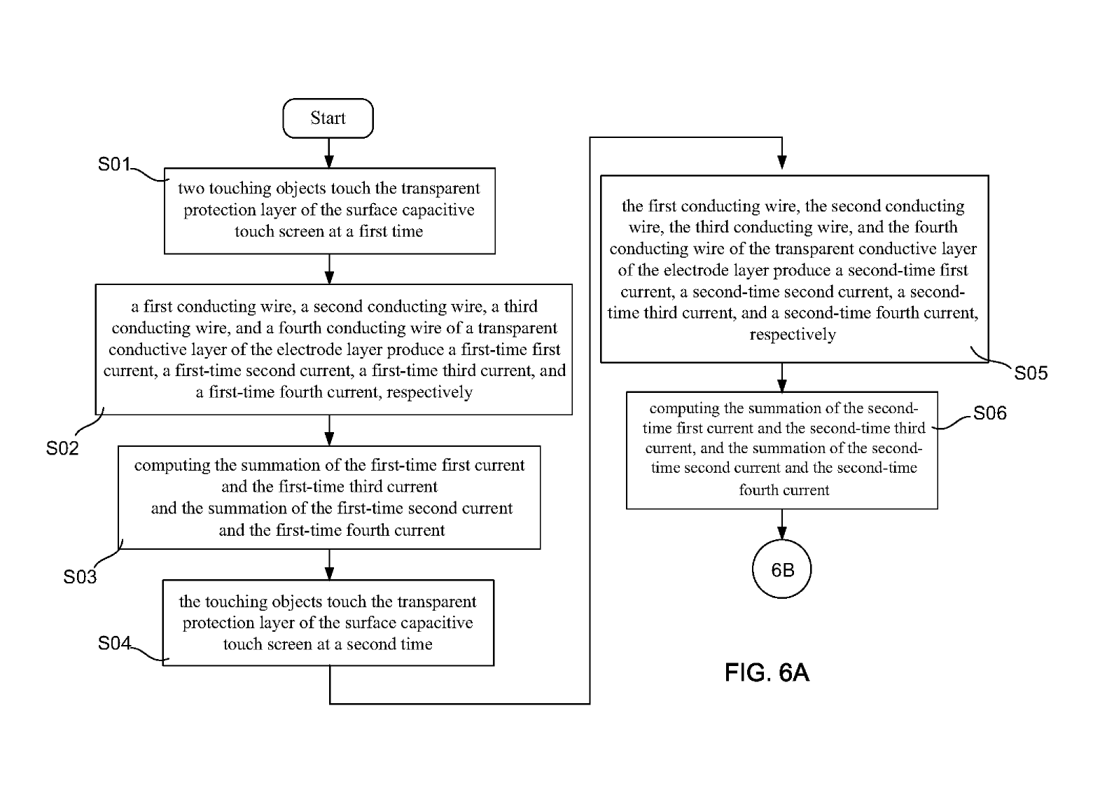

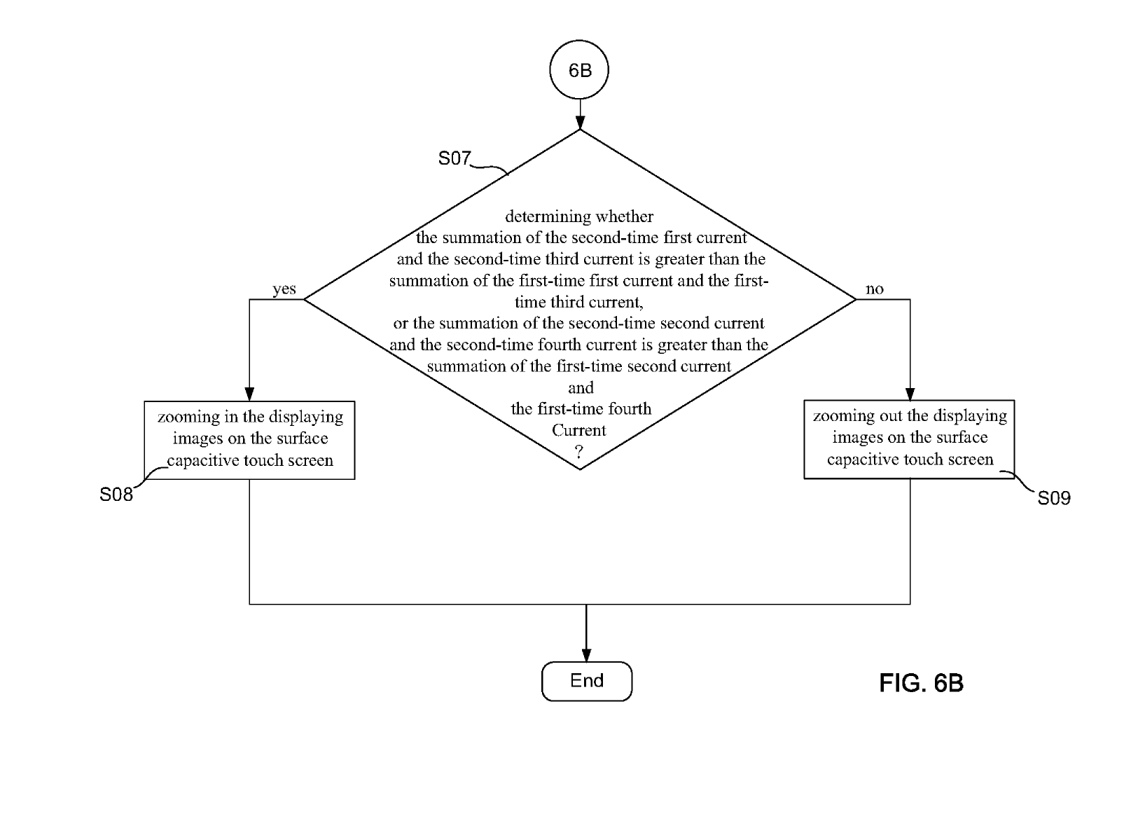

After introducing the structure of the surface capacitive touch screen 1, the touch gesture identification method for the surface capacitive touch screen proposed in the present invention will be next introduced and detailed described in follows. Please refer to FIG. 4 and FIG. 5 again, and simultaneously referring to FIG. 6A and FIG. 6B, there are shown flow charts of the touch gesture identification method for the surface capacitive touch screen.

The flow of the touch gesture identification method is firstly preceded to step (S01) and step (S02), two touching objects OT touch the transparent protection layer 13 of the surface capacitive touch screen 1 at a first time, and then the first conducting wire 151, the second conducting wire 152, the third conducting wire 153, and the fourth conducting wire 154 of the transparent conductive layer 120 of the electrode layer 12 produce a first-time first current I₁₁, a first-time second current I₂₁, a first-time third current I₃₁, and a first-time fourth current I₄₁, respectively. Next, the method flow is proceeded to step (S03), a back-end processor (not shown) computes the summation of the first-time first current I₁₁ and the first-time third current I₃₁ as well as the summation of the first-time second current I₂₁ and the first-time fourth current I₄₁.

After that the flow is proceeded to step (S04) and step (S05), the touching objects OT touch the transparent protection layer 13 of the surface capacitive touch screen 1 at a second time, and then the first conducting wire 151, the second conducting wire 152, the third conducting wire 153, and the fourth conducting wire 154 of the transparent conductive layer 120 of the electrode layer 12 produce a second-time first current I₁₂, a second-time second current I₂₂, a second-time third current I₃₂, and a second-time fourth current I₄₂, respectively. Next, the flow is proceeded to step (S06), the back-end processor computes the summation of the second-time first current I₁₂ and the second-time third current I₃₂, and the summation of the second-time second current I₂₂ and the second-time fourth current I₄₂. Sequentially, in step (S07), it determines whether the summation of the second-time first current I₁₂ and the second-time third current I₃₂ is greater than the summation of the first-time first current I₁₁ and the first-time third current I₃₁ (i.e., if (I₁₂+^{I}₃₂)^{>}(^{I}₁₁+I₃₁) ?), or the summation of the second-time second current I₂₂ and the second-time fourth current I₄₂ is greater than the summation of the first-time second current I₂₁ and the first-time fourth current I₄₁ (i.e., if (I₁₂+I₃₂)>(I₁₁+I₃₁)?). In the step (S07), when (I₁₂+I₃₂)_{>}(I₁₁+I₃₁), it means that the touch gesture is a “zooming-in gesture”, and then step (8) would be processed for zooming in the displaying images on the surface capacitive touch screen 1. On the contrary, when (I₁₂ +I₃₂)>(I₁₁ I₃₁), it means that the touch gesture is a “zooming- out gesture”, and then step (9) would be processed for zooming out the displaying images on the surface capacitive touch screen 1.

Moreover, as sown in FIG. 4, when the touching objects touch a touching point P on the transparent protection layer 13 of the surface capacitive touch screen 1 at the first time, the electrode layer 120 would produce a first current difference ΔI₁, a second current difference ΔI₂, a third current difference ΔI₃, and a fourth current difference ΔI₄, therefore the back-end processor can computes the X-axis coordinate position and the Y-axis coordinate position according to following formula:

X-axis coordinate position=[(ΔI3+ΔI4)−ΔI1−ΔI1−ΔI2]/[ΔI1+ΔI2+ΔI3+ΔI4]

and

Y-axis coordinate position=[(ΔI1+ΔI4)−ΔI3−ΔI2]/[ΔI1+ΔI2+ΔI3+ΔI4],

wherein the first current differenceΔI₁ is obtained by subtracting the first-time first current from the second-time first current I₁₂, the second current difference ΔI₂ is obtained by subtracting the first-time second current I₂₁ from the second-time second current I₁₂, the third current difference ΔI₃ is obtained by subtracting the first-time third current I₃₁ from the second-time third current I₂₂, and the fourth current difference ΔI₄ is obtained by subtracting the first-time fourth current I₄₁ from the second-time fourth current I₄₂.

Thus, above descriptions have been completely and clearly disclosed the touch gesture identification method for surface capacitive touch screen proposed by the present invention, and in summary, the present invention has the following advantages:

1. The surface capacitive touch screen is made of a transparent substrate, an electrode layer and a transparent protection layer, therefore, the surface capacitive touch screen has advantages of simple framework, easy to be manufactured and low cost.
2. The touch Gesture identification method of the present invention can be used for identifying a touch gesture made by at least two touching objects to a surface capacitive touch screen, and then zooming in or zooming out the displaying images on the screen by way of computing the difference between a first-time sensed current and a second-time sensed current resulted from the touch gesture.
3. Inheriting to above point 1 and pint 2, because this touch Gesture identification method and the surface capacitive touch screen have the advantages of simple framework, easy to be manufactured and low cost and can be widely applied in the surface capacitive touch screens with various screen sizes; for example, smart phones, tablet PCs, notebooks, industrial PCs, POS systems, ATMs, medical devices, monitors, game consoles, game machines, etc.

The above description is made on embodiments of the present invention. However, the embodiments are not intended to limit scope of the present invention, and all equivalent implementations or alterations within the spirit of the present invention still fall within the scope of the present invention.

I claim:

1. A touch gesture identification method for surface capacitive touch screen, being used for identifying a touch gesture made by at least two touching objects to a surface capacitive touch screen having a transparent substrate, an electrode layer and a transparent protection layer, and comprising the steps of:
(1) at least two touching objects touching the transparent protection layer of the surface capacitive touch screen at a first time;
(2) a first conducting wire, a second conducting wire, a third conducting wire, and a fourth conducting wire of a transparent conductive layer of the electrode layer producing a first-time first current, a first-time second current, a first-time third current, and a first-time fourth current, respectively;
(3) computing the summation of the first-time first current and the first-time third current, and the summation of the first-time second current and the first-time fourth current;
(4) the touching objects touching the transparent protection layer of the surface capacitive touch screen at a second time;
(5) the first conducting wire, the second conducting wire, the third conducting wire, and the fourth conducting wire of the transparent conductive layer of the electrode layer producing a second-time first current, a second-time second current, a second-time third current, and a second-time fourth current, respectively;
(6) computing the summation of the second-time first current and the second-time third current, and the summation of the second-time second current and the second-time fourth current;
(7) determining whether the summation of the second-time first current and the second-time third current is greater than the summation of the first-time first current and the first-time third current, or the summation of the second-time second current and the second-time fourth current is greater than the summation of the first-time second current and the first-time fourth current, if yes, going to step (8); otherwise, going to step (9);
(8) zooming in the displaying images on the surface capacitive touch screen, and ending step; and
(9) zooming out the displaying images on the surface capacitive touch screen, and ending step.

2. The touch gesture identification method for surface capacitive touch screen of claim 1, wherein the side edges of the electrode layer are formed with a first X electrode, a second X electrode, a first Y electrode, and a second Y electrode, respectively; in which two ends of the first X electrode are connected to the first Y electrode and the second Y electrode, in which the second X electrode is opposite to the first X electrode and connected to the first Y electrode and the second Y electrode by two ends thereof.

3. The touch gesture identification method for surface capacitive touch screen of claim 2, wherein the connecting end of the first X electrode and the first Y electrode is coupled with the first conducting wire, the connecting end of the first Y electrode and the second X electrode being coupled with the second conducting wire, the connecting end of the second X electrode and the second Y electrode being coupled with the third conducting wire, and the connecting end of the second Y electrode and the first X electrode being coupled with the fourth conducting wire.

4. The touch gesture identification method for surface capacitive touch screen of claim 1, wherein the touching objects is selected from the group consisting of: finger and stylus.

5. The touch gesture identification method for surface capacitive touch screen of claim 1, wherein the touch gesture is selected from the group consisting of: zooming out, zooming in and dragging.

6. The touch gesture identification method for surface capacitive touch screen of claim 1, wherein one of the touching object touches the transparent protection layer of the surface capacitive touch screen at the first time, the electrode layer would produce a first current difference, a second current difference, a third current difference, and a fourth current difference.

7. The touch gesture identification method for surface capacitive touch screen of claim 6, wherein the first current difference is obtained by subtracting the first-time first current from the second-time first current, the second current difference being obtained by subtracting the first-time second current from the second-time second current, the third current difference being obtained by subtracting the first-time third current from the second-time third current, and the fourth current difference being obtained by subtracting the first-time fourth current from the second-time fourth current.

8. The touch gesture identification method for surface capacitive touch screen of claim 7, wherein when one of the touching object touches a touching point on the transparent protection layer of the surface capacitive touch screen at the first time, the X-axis coordinate position of the touching point can be computed by following formula: x=[(third current difference+fourth current difference)−(first current difference+second current difference)]/(first current difference+second current difference+third current difference+fourth current difference).

9. The touch gesture identification method for surface capacitive touch screen of claim 7, wherein when one of the touching object touches a touching point on the transparent protection layer of the surface capacitive touch screen at the first time, the Y-axis coordinate position of the touching point can be computed by following formula: y=[(first current difference+fourth current difference)−(second current difference+third current difference)]/(first current difference+second current difference+third current difference+fourth current difference).

10. The touch gesture identification method for surface capacitive touch screen of claim 1, wherein the material of the transparent substrate is selected from the group consisting of: glass, polymethylmethacrylate (PMMA) and polyethylene terephthalate (PET).

11. The touch gesture identification method for surface capacitive touch screen of claim 1, wherein the material of the transparent conductive layer is selected from the group consisting of: Indium-Tin-Oxide (ITO) and carbon nanotube (CNT).

12. The touch gesture identification method for surface capacitive touch screen of claim 1, wherein the material of the transparent protection layer is selected from the group consisting of: SiO₂, glass, polymethylmethacrylate (PMMA), and polyethylene terephthalate (PET).
